(19) United States
(12) Patent Application Publication
(10) Pub. No.: US 2026/0217180 A1
(43) Pub. Date: Jul. 30, 2026

(54) COMBINED RAIL-TYPE TWO-STAGE SLIDE OUT SYSTEM FOR VEHICLE EXPANDABLE COMPARTMENT

(71) Applicant: Xinfang Zhang, Shanxi (CN)

(72) Inventor: Xinfang Zhang, Shanxi (CN)

(21) Appl. No.: 19/038,659

(22) Filed: Jan. 27, 2025

(51) Int. Cl. B60P 3/34

(52) U.S. Cl. CPC B60P 3/34

(57) ABSTRACT

This application pertains to a combined rail-type two-stage slide-out system for a vehicle expandable compartment, including a drive mechanism, support frame, combined rail mechanism, load-bearing box, and slide out compartment. The drive mechanism, part of the support frame (excluding the bottom plate), and the combined rail mechanism are integrated within the load-bearing box, symmetrically arranged below the slide out compartment on both sides. The slide out compartment can achieve two-stage extension. The system does not require disassembly of the lower chassis of the vehicle; it only needs to fix the support frame on the vehicle body to set the entire slide out compartment at the opening of the vehicle body, aligning the slide out compartment with the exterior of the vehicle body. The application achieves two-stage extension, increasing the usable space of the vehicle, presenting a neat appearance, and being easy to install and remove.

### TECHNICAL FIELD

This invention relates to the field of vehicle interior space expansion technology, particularly to a two-stage slide out system with combination rails for vehicle expandable compartment.

### BACKGROUND OF THE INVENTION

Existing vehicles and RVs are equipped with extendable boxes to increase internal usable space. The outer walls of these extendable boxes align with the exterior of the vehicle or trailer during travel, and when the vehicle stops, the box is extended outward from the vehicle's opening to increase internal use space.

Patent No. CN202111541306.4 discloses an RV extension mechanism where the sliding mechanism is located below and on the sides of the vehicle body, lacking integrated design, occupying significant space, being inconvenient for installation, and operating unstably.

Patent No. US202117408020 describes a sliding device set on both sides of the extendable box. Due to the complexity of the mechanisms, the telescopic drive device is too high, occupies considerable space, is inconvenient for maintenance, and increases costs.

Regarding technologies, the inventor believes that the sliding mechanism of vehicle expandable compartment extension systems is relatively large, complex to install, and costly. Therefore, it is considered that the sliding mechanism of vehicle extendable boxes has the issue of occupying substantial space, being inconvenient for installation and operating.

### SUMMARY OF THE INVENTION

To address the problem of the sliding mechanism of vehicle extendable boxes occupying substantial space, this invention provides a two-stage slide out system with combination rails for vehicle expandable compartment. The slide out system is integrated at the bottom of both sides of the slide out compartment. The mechanism remains suspended, effectively supporting and bearing the entire weight of the sliding compartment. Utilizing this mechanism in vehicle slide-out systems can save space and improve spatial efficiency. And since the entire sliding mechanism is integrally connected to the support frame base plate, there is no need to dismantle the lower chassis of the vehicle body. Installation and removal are convenient; simply fix the support frame's base plate to the vehicle body, allowing the entire extendable compartment to be placed at the vehicle's opening.

### DETAILED DESCRIPTION OF THE PREFERRED EMBODIMENTS

To achieve the above objectives, this invention adopts the following technical solution:

A two-stage slide out system with combination rails for a vehicle's expandable compartment comprises a drive mechanism, support frame, combination rail assembly, load-bearing box, and slide out compartment. The combination rail assembly is fixed on one side to the support frame and on the other side to the load-bearing box. The drive mechanism is mounted on the support frame, which in turn is attached to the vehicle body. The drive mechanism, part of the support frame (excluding the bottom plate), and the combination rail assembly are integrated within the load-bearing box. The load-bearing boxes are symmetrically positioned at the bottom of both sides of the slide out compartment. A long slot is set at the bottom of each load-bearing box, allowing it to slide back and forth along the lower end of the support frame.

This design isolates the combination rail assembly and drives mechanism from external influences, facilitates installation and removal, maintains an aesthetically pleasing appearance, and increases internal vehicle space utilization. The symmetrical positioning of the load-bearing boxes supports the weight of the slide out compartment in a suspended manner.

Preferably, the drive mechanism includes a rack, pinion, reducer, and motor. The rack is fixed to the side wall of the load-bearing box. The motor's output shaft connects to the reducer, whose output shaft has a pinion secured by snap rings A and B. The motor drives the pinion through the reducer, converting its rotational motion into linear motion via engagement with the rack.

This setup transforms the pinion's rotational movement into the rack's linear motion, facilitating the extension and retraction of the slide out compartment.

The bottom plate of the support frame features mounting holes for securing it to the vehicle body. Vertical plates on either side of the support frame have an extension limiter and retraction limiter. This configuration ensures that the support frame transfers weight to the vehicle body, keeping the slide out compartment suspended without interference. It also supports the drive mechanism while limiting the extent of slide-out and retraction movements to prevent disengagement of the load-bearing box.

The combination rail assembly consists of primary rail, secondary rail, fixing plate, and four slides (slides one, two, three, and four). Slides one and two connect slidably with the primary rail, while slides three and four connect slidably with the secondary rail. This arrangement minimizes friction and enables smooth linear motion.

The primary rail is fixed to the side wall of the load-bearing box, with slides one and two attached to the fixing plate and slides three and four to the support frame. This setup allows the load-bearing box to move the primary rail while supporting the weight of the combination rail assembly.

The primary rail is featured with mounting holes for mounting a first end stop, which has a detent pin. The fixing plate has a corresponding slot for this detent pin. The secondary rail is fixed to the fixing plate and featured with mounting holes for second end stop.

By adopting the technical solution, the combination rails mechanism can perform a two-stage extension motion. It can support the weight of the sliding compartment in a suspended manner, enabling the compartment to slide out and retract, thereby expanding the usable space within the vehicle. When the primary guide rail slides outward, the detent pin moves along the slot until it reaches the bottom, which then triggers the secondary guide rail to slide out further. The sliding process concludes when the second end stop meets the extension limiter.

Secondly, the rail has mounting holes for a third end stop. A sealing plate is set along the length of the load-bearing box. During retraction, when the sealing plate contacts the third end stop, it initiates the inward sliding of the secondary rail.

The primary and secondary rails, along with the fixing plate, remain cantilevered during extension and retraction, increasing the extension length without requiring additional support.

During travel, the slide out compartment aligns flush with the exterior plane of the vehicle body, reducing environmental impact and maintaining an attractive appearance.

In summary, this application offers the following advantages:
1. The integration of the combination rail assembly, drive mechanism, and part of the support frame within the load-bearing boxes on both sides of the slide out compartment enables synchronized two-stage extension, increasing interior space.
2. This integrated design shields the combination rail assembly and drives mechanism from external factors, simplifies installation, enhances aesthetics, and increases interior space.
3. The entire combination rail assembly is connected to the support frame inside the load-bearing box, eliminating the need to dismantle the vehicle's chassis; only the bottom plate of the support frame needs to be fixed to the vehicle body.
4. Weight transfer occurs from the slide out compartment to the combination rails, then to the support frame, and finally to the vehicle body.
5. Alignment of the slide out compartment with the vehicle body reduces environmental impact and improves aesthetics.

### BRIEF DESCRIPTION OF DRAWINGS

To clearly explain the technical solutions of this invention, the drawings used in the description will be briefly introduced. The FIGS. described below are merely some embodiments of this invention. Based on these drawings, those skilled in the art can obtain other drawings without creative work.

FIG. 1 shows a partial sectional view of the slide out compartment in a specific embodiment of the present invention.

FIG. 2 shows a side view of the slide out compartment in a specific embodiment of the present invention.

FIG. 3 illustrates the structure of the slide-out mechanism for the vehicle expandable compartment in a specific embodiment of the present invention.

FIG. 4 provides an exploded view of the drive mechanism in the slide-out system for the vehicle expandable compartment in a specific embodiment of the present invention.

FIG. 5 illustrates the structure of the support frame in a specific embodiment of the present invention.

FIG. 6 shows the structural diagram of the box body of the load-bearing box in a specific embodiment of the present invention.

FIG. 7 provides an exploded view of the combined rail structure in a specific embodiment of the present invention.

FIG. 8 provides an exploded view of the slide-out mechanism in a specific embodiment of the present invention.

FIG. 9 shows the front and rear views of the internal structure of the load-bearing box in a specific embodiment of the present invention.

FIG. 10 shows a side view of the internal structure of the load-bearing box in a specific embodiment of the present invention.

FIG. 11 illustrates the fully extended configuration of the vehicle slide-out system in a specific embodiment of the present invention.

FIG. 12 illustrates the fully retracted configuration of the vehicle slide-out system in a specific embodiment of the present invention.

FIG. 13 illustrates the schematic diagrams of the slide-out mechanism at different stages: not extended (13A), during extension (13B), and fully extended (13C) in a specific embodiment of the present invention.

FIG. 14 illustrates the schematic diagrams of the slide-out mechanism at different stages: fully extended (14A), during retraction (14B), and fully retracted (14C) in a specific embodiment of the present invention.

### BRIEF DESCRIPTION OF THE FIGS.

The following are the reference numbers that appear in the drawings:
1. Slide out compartment
2. Load-bearing box
3. Support frame
4a. Slider one
4b. Slider two
4c. Slider three
4d. Slider four
5. Primary rail
6. Secondary rail
7. Fixing plate
8a. First end stop
8b. Second end stop
8c. Third end stop
9. Rack
10. Gear
11. Reducer
12. Motor
13a. First retaining ring
13b. Second retaining ring
14. Slot
15. Detent pin
16. Sealing plate
17. Long slot opening
18. Retraction limiter
19. Extension limiter
20. Mounting holes
21. Reducer mounting plate
23. Drive mechanism
24. Combined rail assembly
25a. First installation hole
25b. Second installation hole
25c. Third installation hole
26. Vehicle body

### DETAILED DESCRIPTION OF THE INVENTION

To make the purpose, features, and advantages of this invention more apparent and understandable, the following detailed description of the technical solutions of this invention will be provided in conjunction with the accompanying drawings, illustrating only some of the embodiments of this invention. Based on the embodiments of this patent, those skilled in the art can obtain other embodiments without making any creative effort, all of which fall within the scope protected by this patent.

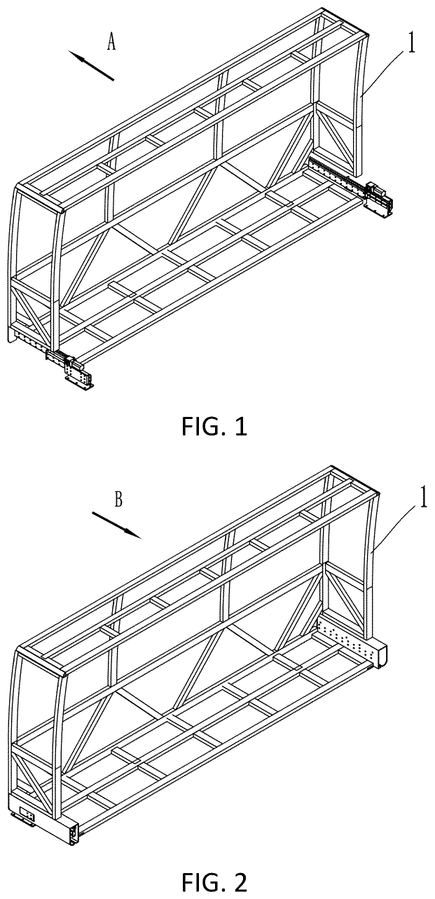

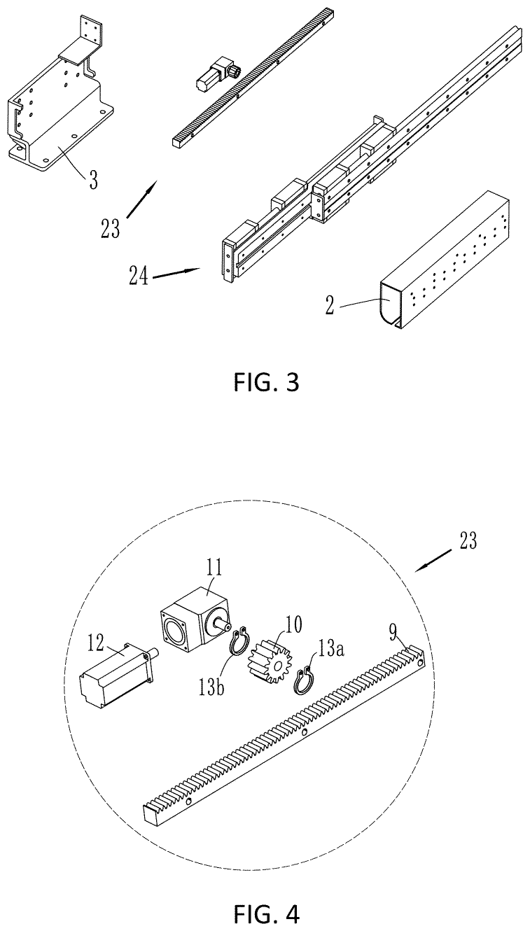

Referring to FIGS. 1, 2, and 3: A vehicle expandable compartment slide-out system includes a drive mechanism 23, support frame 3, combined rail mechanism 24, load-bearing box 2, and slide out compartment 1. The slide out compartment 1 is made of aluminum alloy or other lightweight rigid materials, with corresponding load-bearing boxes 2 set at the lowest part of the opposite side walls. Both load-bearing boxes 2 have identical internal structures, are correspondingly set up, and move synchronously, supporting the weight of the slide out compartment 1. The combined rail mechanism 24, drive mechanism 23, and part of the support frame 3 (excluding the bottom plate) are integrated inside the load-bearing box 2, which saves space and facilitates quick installation and removal.

Referring to FIG. 4: The drive mechanism 23 comprises a rack 9, gear 10, reducer 11, and motor 12. The output shaft of the motor 12 is connected to the reducer 11, whose output shaft is fixed with the gear 10 via retaining rings 13a and 13b. The motor 12 drives the rotation of the gear 10 through the reducer 11, converting the rotational motion of the gear 10 into linear motion of the rack 9 through meshing.

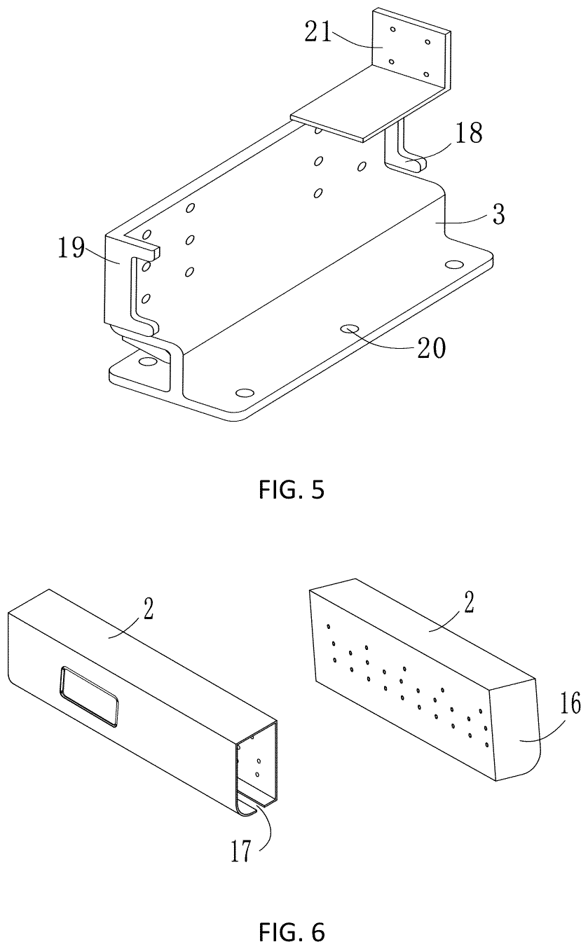

Referring to FIG. 5: The base plate of the support frame 3 has vehicle mounting holes 20, through which the support frame 3 is fixed to the vehicle body 26. Both sides of the vertical plate of the support frame 3 have an extension limiter 19 and retraction limiter 18.

Referring to FIG. 6: The bottom of the load-bearing box 2 has a long slot opening 17, allowing it to slide back and forth along the vertical plates of the support frame 3. The rack 9 is installed on the outer side wall of the load-bearing box 2, which also has a sealing plate 16 mounted on the lengthwise end.

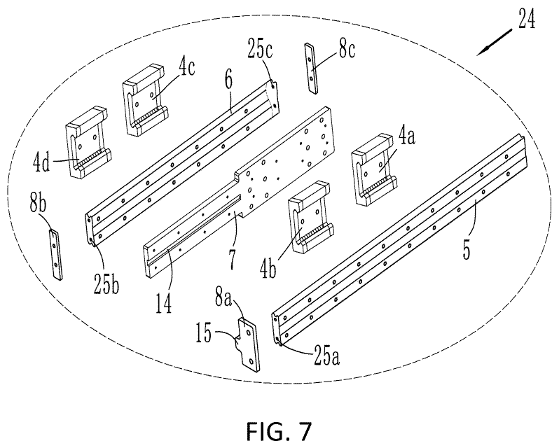

Referring to FIG. 7: The combined rail mechanism includes primary rail 5, secondary rail 6, fixing plate 7, and four sliders 4a, 4b, 4c, and 4d. The primary rail 5 is fixedly connected to the side wall of the load-bearing box 2, and near the interior of the vehicle, there are mounting holes 25a for fixing the first end stop 8a, which has a detent pin 15 that corresponds to a slot 14 on the fixing plate 7. The secondary rail 6 and the fixing plate 7 are fixedly connected, and the secondary rail 6 has mounting holes two 25b for fixing the second end stop 8b and three 25c for fixing the third end stop 8c on either side. Sliders one 4a and two 4b are slidingly connected to the primary rail 5, while sliders three 4c and four 4d are slidingly connected to the secondary rail 6. Sliders one 4a and two 4b are fixed on the fixing plate 7, and sliders three 4c and four 4d are fixed on the support frame 3. The primary rail 5, secondary rail 6, and fixing plate 7 remain cantilevered during the extension and retraction of the slide out compartment 1.

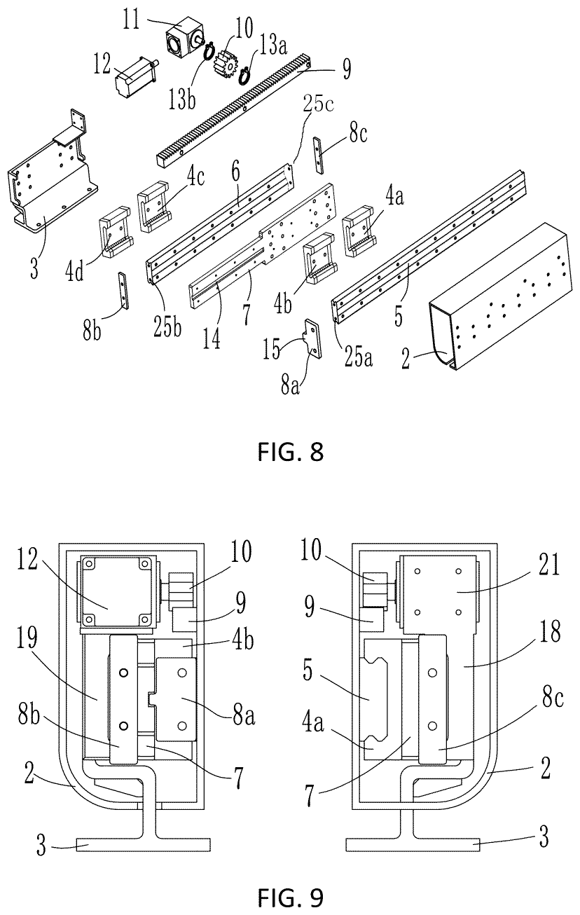

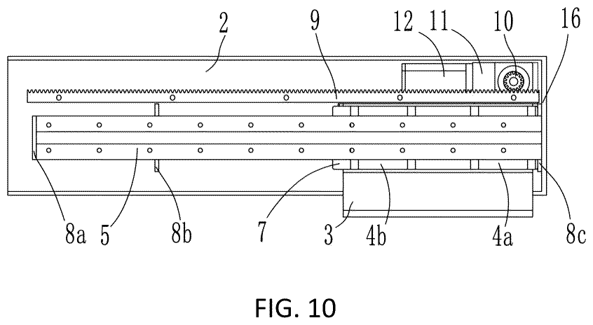

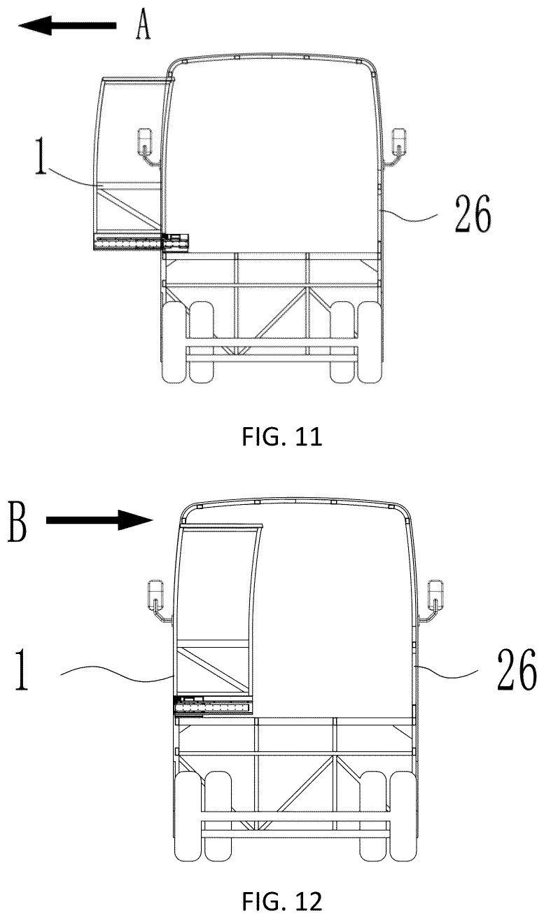

Referring to FIG. 8 as the exploded view of the slide-out mechanism, FIG. 9 as the front and rear view of the internal structure of the load-bearing box, and FIG. 10 as the side view of the internal structure of the load-bearing box.

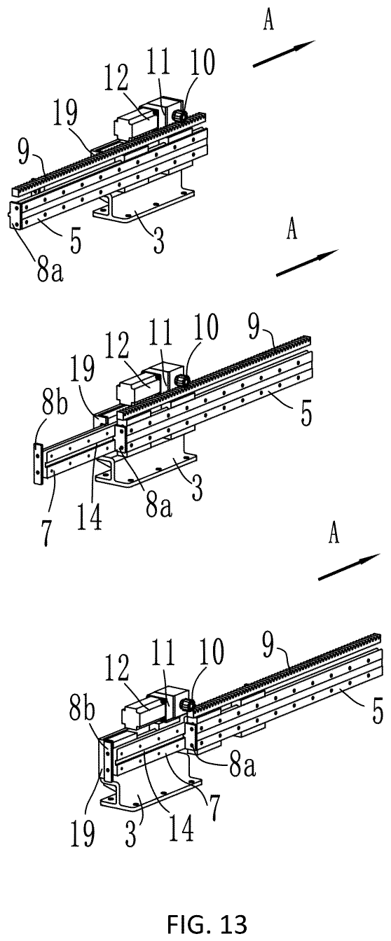

Referring to FIG. 13: When the vehicle expandable compartment slide-out system extends, the motor 12 drives the reducer 11 to rotate, causing the gear 10 to rotate under the action of the reducer 11. The rack 9 converts the spiral motion into linear motion under the effect of the gear 10, pulling the load-bearing box 2 outward. As the load-bearing box 2 slides out, it brings the primary rail 5 along with it. After sliding a certain distance, when the detent pin 15 reaches the end of the slot 14, it pulls the secondary rail 6 outward. When the second end stop 8b hits the extension limiter 19, the extension process ends, achieving a two-stage extension.

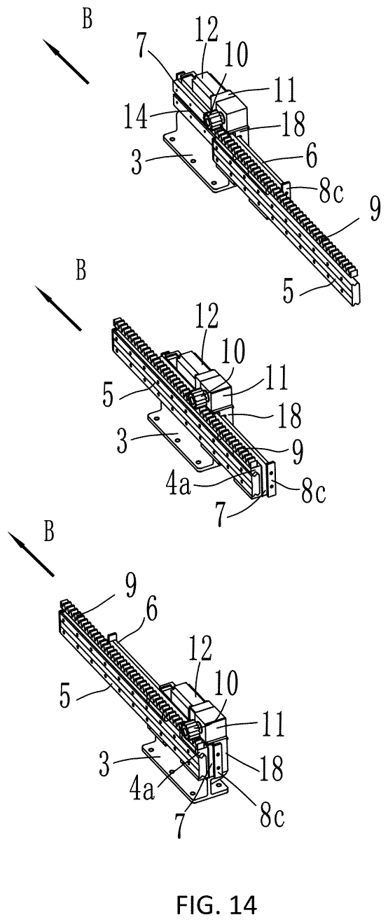

Referring to FIG. 14: When the vehicle expandable compartment slide-out system retracts, the motor 12 drives the reducer 11 to rotate in reverse, causing the gear 10 to rotate inversely under the action of the reducer 11, thereby pulling the load-bearing box 2 inward. The load-bearing box 2 brings the primary rail 5 inward together. After retracting a certain distance, when the sealing plate 16 hits the third end stop 8c, it pulls the secondary rail 6 inward together. When the third end stop 8c hits the retraction limiter 18, the retraction process ends, achieving a two-stage retraction.

The above description of the disclosed embodiments enables those skilled in the art to implement or use the present invention. Modifications to these embodiments will be apparent to those skilled in art, and the general principles defined herein can be implemented in other embodiments without departing from the spirit or scope of the invention.

1. A combined rail-type two-stage slide-out system for a vehicle expandable compartment comprising a drive mechanism, a support frame, a combined rail mechanism, a load-bearing box, and a slide out compartment, wherein one side of the combined rail mechanism is fixed to support frame, and the other side is fixed to the outer side wall of the load-bearing box, the drive mechanism is fixed on the support frame, the support frame is fixed on the vehicle body, and the drive mechanism, part of the support frame (excluding the base plate), and the combined rail mechanism are integrated within the load-bearing box. The load-bearing box is symmetrically arranged at the lowest part of the slide out compartment on both sides, the bottom of the load-bearing box has a long slot opening, and the load-bearing box slides back and forth at the lower end of the support frame through the long slot opening.

2. According to claim 1, the drive mechanism includes a rack, a gear, a reducer, and a motor. The rack is fixed on the side wall of the load-bearing box, the output shaft of the motor is connected to the reducer, the output shaft of the reducer is fixed with the gear via retaining rings, the motor drives the gear to rotate through the reducer, and the teeth of the gear mesh with the teeth of the rack, converting the rotary motion of the gear into the linear motion of the rack.

3. According to claim 2, the bottom plate of the support frame has mounting holes, the support frame is fixed on the vehicle body through the mounting holes, and both sides of the vertical plate also have extension limiter and retraction limiter.

4. According to claim 3, the combined rail mechanism includes primary rail, secondary rail, a fixing plate, slider one, slider two, slider three, and slider four, where slider one and slider two are slidably connected to the primary rail, and slider three and slider four are slidably connected to the secondary rail.

5. According to claim 4, the primary rail is fixed on the side wall of the load-bearing box, slider one and slider two are fixed on the fixing plate, and slider three and slider four are fixed on the support frame.

6. According to claim 5, the primary rail has mounting holes on the end closer to the interior of vehicle for fixing first end stop, which has a detent pin. The fixing plate has a corresponding slot for the pin, and the secondary rail and the fixing plate are fixedly connected. The secondary rail has mounting holes on the side closer to the interior of the vehicle for fixing second end stop.

7. According to claim 6, the secondary rail has mounting holes on the other side for fixing third end stop, and the load-bearing box has a sealing plate mounted on the lengthwise end.

8. According to claim 7, the primary rail, the secondary rail, and the fixing plate remain cantilevered during the extension and retraction of the slide out compartment.

9. According to claim 8, the slide out compartment flushes with the outer plane of the vehicle body during vehicle operation.
